(19) United States
(12) Patent Application Publication
(10) Pub. No.: US 2026/0110872 A1
(43) Pub. Date: Apr. 23, 2026

(54) LENS AND LENS ASSEMBLY INCLUDING THE SAME

(71) Applicant: Samsung Electro-Mechanics Co., Ltd., Suwon-si (KR)

(72) Inventors: So Mi YANG, Suwon-si (KR); Jae Hyuk HUH, Suwon-si (KR); In Do SEO, Suwon-si (KR)

(73) Assignee: Samsung Electro-Mechanics Co., Ltd., Suwon-si (KR)

(21) Appl. No.: 19/284,501

(22) Filed: Jul. 29, 2025

(30) Foreign Application Priority Data
Oct. 21, 2024 (KR) 10-2024-0144249
Apr. 16, 2025 (KR) 10-2025-0049689

(51) Int. Cl. G02B 7/02; G02B 7/00; G02B 13/00; G03B 17/12; G03B 30/00

(52) U.S. Cl. CPC G02B 7/021; G02B 7/003; G02B 13/0045; G03B 17/12; G03B 30/00

(57) ABSTRACT

A lens includes an optical portion including a pair of straight portions facing each other in a direction perpendicular to an optical axis, and an arc portion connecting the pair of straight portions; and a flange portion extending along a portion of a perimeter of the optical portion, wherein the flange portion extends from a straight portion of the straight portions and is spaced apart from the arc portion, and the optical portion refracts light.

### CROSS-REFERENCE TO RELATED APPLICATIONS

This application claims the benefit under 35 USC 119(a) of Korean Patent Application Nos. 10-2024-0144249 filed on Oct. 21, 2024, and 10-2025-0049689 filed on Apr. 16, 2025, in the Korean Intellectual Property Office, the entire disclosures of which are incorporated herein by reference for all purposes.

### BACKGROUND

### 1. Field

The present disclosure relates to a lens and a lens assembly including the same.

### 2. Description of the Background

Camera modules are commonly used in portable electronic devices, such as smartphones, and as portable electronic devices are increasingly becoming smaller, camera modules mounted on portable electronic devices are also becoming smaller. In addition, apart from the need for miniaturization, improvements in the performance of camera modules are also desired.

Generally, an image sensor of a camera module is rectangular, and a lens refracting light is circular, so the entirety of light refracted by the lens is not focused on the image sensor. Therefore, a method of reducing the size of the lens by removing unnecessary parts from the lens and thereby reducing the size of the camera module may be considered. For example, a lens in which both sides of a circular lens are removed (hereinafter, referred to as a D-cut lens) may be utilized.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens includes an optical portion including a pair of straight portions facing each other in a direction perpendicular to an optical axis, and an arc portion connecting the pair of straight portions; and a flange portion extending along a portion of a perimeter of the optical portion, wherein the flange portion extends from a straight portion of the straight portions and is spaced apart from the arc portion, and the optical portion refracts light.

A distance W1 between the pair of straight portions may be less than a maximum diameter D1 of the optical portion.

A ratio (W1/D1) of the distance W1 between the pair of straight portions to the maximum diameter D1 of the optical portion may be greater than 0.5 and less than 0.9.

The lens may further include a protrusion extending from the arc portion and spaced apart from each of the straight portions. A distance W2 between outermost surfaces of the flange portion extending from one of the straight portions and another flange portion extending from the other of the straight portions may be less than a maximum diameter D2 of the lens including the protrusion.

A ratio (W1/W2) of a distance W1 between the pair of straight portions to the distance W2 between the outermost surfaces of the flange portion and the other flange portion respectively extending from the straight portions may be greater than 0.80 and less than 0.98.

A ratio (D1/D2) of a maximum diameter D1 of the optical portion to the maximum diameter D2 of the lens including the protrusion may be greater than 0.85 and less than 0.98.

A side surface of the protrusion may include first and second vertical surfaces, parallel to the optical axis, first and second horizontal surfaces, perpendicular to the optical axis, and first and second inclined surfaces inclined in opposite directions.

Based on a cross-section parallel to the optical axis and passing through the protrusion, a length of each of the first and second vertical surfaces may be greater than 0.01 mm and less than 0.1 mm.

Based on a cross-section parallel to the optical axis and passing through the protrusion, a length of each of the first and second horizontal surfaces may be greater than 0.01 mm and less than 0.1 mm.

An angle between the second inclined surface and the optical axis may be greater than 3 degrees and less than 20 degrees.

A side surface of the flange portion may include an outer diameter portion disposed at an outermost side parallel to the optical axis, third and fourth horizontal surfaces perpendicular to the optical axis, and third and fourth inclined surfaces inclined in opposite directions.

An angle between the fourth inclined surface and the optical axis may be greater than 10 degrees and less than 70 degrees.

The pair of straight portions may face each other in a first axis direction, and the optical portion may further include another pair of straight portions facing each other in a second axis direction perpendicular to the optical axis and the first axis, and may further include flange portions respectively extending from the other pair of straight portions.

In another general aspect, a lens assembly includes a lens barrel; a plurality of lenses stacked in a direction of an optical axis within the lens barrel, each lens in the plurality of lenses comprising an optical portion refracting light and a flange portion extending along a perimeter of the optical portion; and a spacer disposed between two adjacent lenses among the plurality of lenses. The optical portion includes a pair of straight portions facing each other in a direction perpendicular to the optical axis, and an arc portion connecting the pair of straight portions, the flange portion extends from the straight portion and is spaced apart from the arc portion, and the spacer is in contact with the flange portion.

A curvature of the straight portion may be less than a curvature of the arc portion.

A side surface of the flange portion may include a horizontal surface perpendicular to the optical axis, and an outer diameter portion disposed at an outermost side parallel to the optical axis, the horizontal surface is in contact with the spacer, and the outer diameter portion is in contact with the lens barrel.

Other features and aspects will be apparent from the following detailed description, the drawings, and the claims.

### BRIEF DESCRIPTION OF DRAWINGS

FIG. 1 is a perspective view of a lens according to an embodiment of the present disclosure.

FIG. 2 illustrates a plan view of FIG. 1 and a plan view of an image sensor.

FIG. 3 is a diagram illustrating detailed dimensions on the plan view of FIG. 1.

FIG. 4 is an enlarged view of region A of FIG. 3.

FIG. 5 is a cross-sectional view taken along line I-I′ of FIG. 1.

FIG. 6 is an enlarged view of region B of FIG. 5.

FIG. 7 is a cross-sectional view taken along line II-II′ of FIG. 1.

FIG. 8 is an enlarged view of region C of FIG. 7.

FIG. 9 is a cross-sectional view of a lens assembly according to an embodiment of the present disclosure.

FIG. 10 is a perspective view of a lens according to another embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

A lens assembly according to an embodiment of the present disclosure may be provided in a camera module mounted on a portable electronic device.

In the present disclosure, the portable electronic device may refer to a portable electronic device, such as a mobile communication terminal, a smartphone, or a tablet PC.

A lens 10 according to an embodiment of the present disclosure may correspond to a lens in which both sides of a circular lens are removed (hereinafter, a D-cut lens). The lens 10 of the present embodiment may include an optical portion 100 reflecting light and a flange portion 300 for assembly, and the optical portion 100 may include at least a pair of straight portions 110 facing each other in a direction perpendicular to the optical axis OA.

The optical portion 100 may have refractive power and may be formed as an aspherical surface.

The flange portion 300 may be a portion fixing the lens 10 to another component, for example, a lens barrel 20 or another adjacent lens. The flange portion 300 may extend from the perimeter of the optical portion 100 and may be formed integrally with the optical portion 100.

In the lens 10 of the present embodiment, the flange portion 300 may be disposed only in the straight portion 110 of the perimeter of the optical portion 100, thereby providing the maximum effective diameter within a limited size. That is, the flange portion 300 is not disposed on an arc portion 120 connecting the straight portions 110, thereby providing the maximum effective diameter within a limited size. In this case, the lens 10, according to an embodiment of the present disclosure, may be formed such that a distance W1 between a pair of straight portions 110 is less than a maximum diameter D1 of the optical portion 100, i.e., the effective diameter.

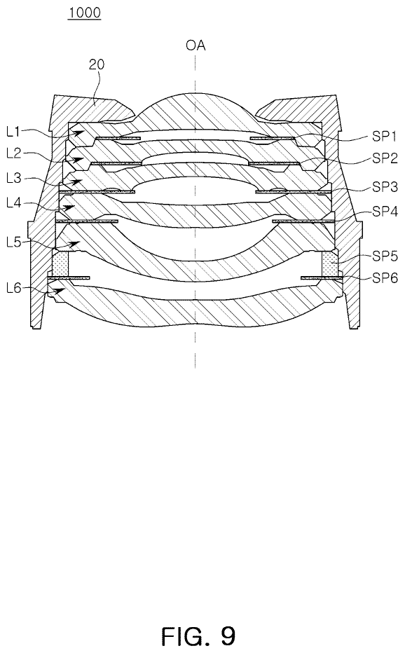

In addition, in a lens assembly 1000 (See FIG. 9) according to an embodiment of the present disclosure, an assembly structure between a plurality of lenses may be formed only in the flange portion 300 extending from the straight portion 110 within the lens barrel 20, thereby reducing the overall size of the lens assembly 1000.

Hereinafter, the detailed features of the lens 10 and the lens assembly 1000 according to an embodiment of the present disclosure will be described in detail with reference to the drawings.

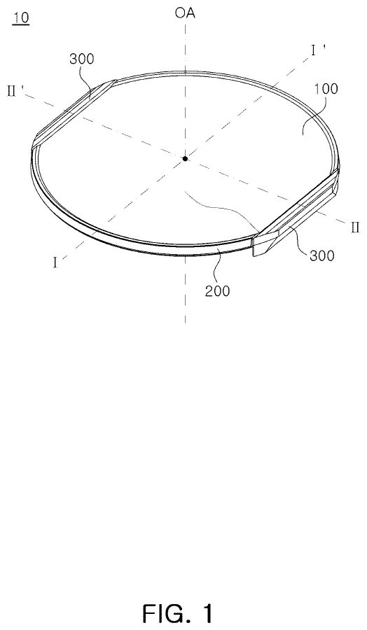

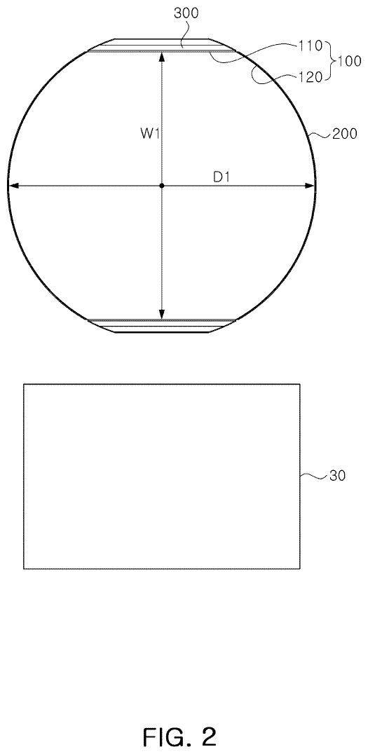

FIG. 1 is a perspective view of the lens 10 according to an embodiment of the present disclosure. FIG. 2 includes a diagram illustrating a plan view of FIG. 1 and a plan view of an image sensor 30.

Referring to FIGS. 1 and 2, the lens 10 according to an embodiment of the present disclosure may include the optical portion 100 reflecting light and the flange portion 300 extending along a portion of the perimeter of the optical portion 100.

In addition, the optical portion 100 of the present embodiment may include a pair of straight portions 110 facing each other in a direction perpendicular to the optical axis, and the arc portion 120 connecting the pair of straight portions 110. Here, the straight portion 110 may correspond to a region having a form in which a side of the circular optical portion 100 is partially removed and may have a straight shape on a plane viewed in the direction of the optical axis OA. However, it does not refer only to a region having an exactly straight shape, and may refer to a region having a curvature close to 0 or having a generally straight shape.

In addition, the arc portion 120 may correspond to a region excluding the straight portion 110 in the perimeter of the circular optical portion 100 and may correspond to a region connecting the straight portions 110. The arc portion 120 of the present embodiment may have an arc shape on a plane viewed in the direction of the optical axis OA. The curvature of the arc portion 120 may be formed to be greater than the curvature of the straight portion 110.

The flange portion 300 of the present embodiment may extend from the straight portion 110 and be spaced apart from the arc portion 120. That is, the flange portion 300 of the present embodiment may not be disposed around the entire perimeter of the optical portion 100, but may be disposed only in the region in which the straight portion 110 is formed. By disposing the flange portion 300 only in the straight portion 110 from which a portion of the effective diameter has been removed, the effective diameter of the arc portion 120 may be fully realized, which may be advantageous for miniaturization.

Referring to FIGS. 1 and 2, the distance W1 between a pair of straight portions 110 of the lens 10 of the present embodiment may be less than the maximum diameter D1 of the optical portion 100, i.e., the effective diameter. Here, the distance W1 between a pair of straight sections 110 may refer to the maximum distance in a short-axis direction for the optical portion 100. In addition, the maximum diameter D1 of the optical portion 100 may refer to the maximum distance in the long-axis direction for the optical portion 100, i.e., the maximum distance excluding a protrusion 200.

FIG. 2 schematically illustrates the shape of the lens 10 of the present embodiment and the image sensor 30 used in the camera module.

Generally, a lens is circular, and the image sensor 30 of the camera module is rectangular, so not the entire light refracted by the circular lens is focused on the image sensor 30.

Therefore, by removing an unnecessary portion from the optical portion 100, such as the lens 10 of the present embodiment, the size of the lens may be reduced, and through this, the size of the lens assembly 1000 and the camera module including the same may be reduced.

In addition, in the lens 10 of the present embodiment, the flange portion 300 may be additionally disposed only in the region of the straight portion 110 from which an unnecessary portion is removed in the optical portion 100, so as to be utilized as an assembly structure. As a result, in the lens 10 of the present embodiment, the maximum diameter, i.e., the effective diameter, passing through the arc portion 120 and the center of the optical axis may be realized within the same size.

Meanwhile, the lens 10 of the present embodiment may be formed of a plastic material and may be injection-molded through a mold. Here, the lens 10 according to the present embodiment may be manufactured to have the shape as described above during an injection-molding operation, rather than that a portion of the lens cut off after injection-molding.

If a portion of the lens is removed after injection molding, there is a concern that the lens may be deformed due to the force applied to the lens during the process. Deformation of the lens may lead to a problem where the optical performance of the lens inevitably changes.

However, since the lens 10 according to the present embodiment has the optical portion 100 and the flange portion 300 formed to be non-circular during injection molding, the size of the lens 10 may be reduced, while the optical performance of the lens 10 may be maintained without deterioration.

In the lens 10 according to the present embodiment, a ratio (W1/D1) of the distance W1 between a pair of straight portions 110 to the maximum diameter D1 of the optical portion 100 may be greater than 0.5 and less than 0.9. If the ratio (W1/D1) is less than 0.5, problems, such as a decrease in refractive index and deterioration in injection moldability, may occur. In addition, if the ratio (W1/D1) is greater than 0.9, the effect of reducing the size of the lens 10 by forming the straight portion 110 may be reduced.

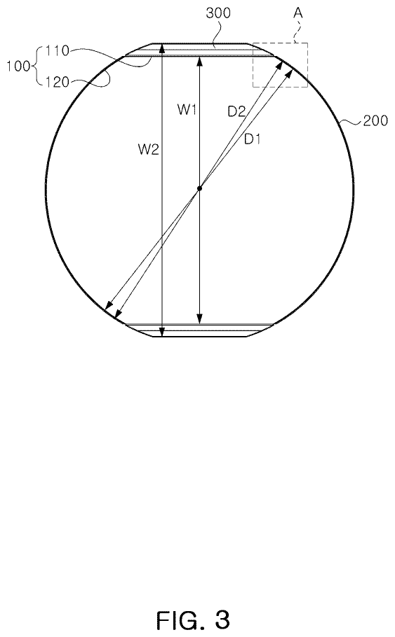

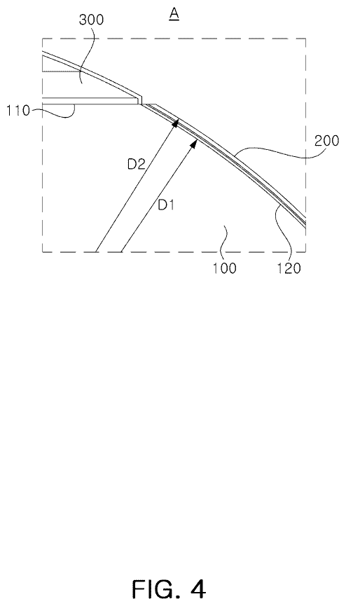

FIG. 3 is a diagram illustrating detailed dimensions in the plan view of FIG. 1. FIG. 4 is an enlarged view of region A of FIG. 3.

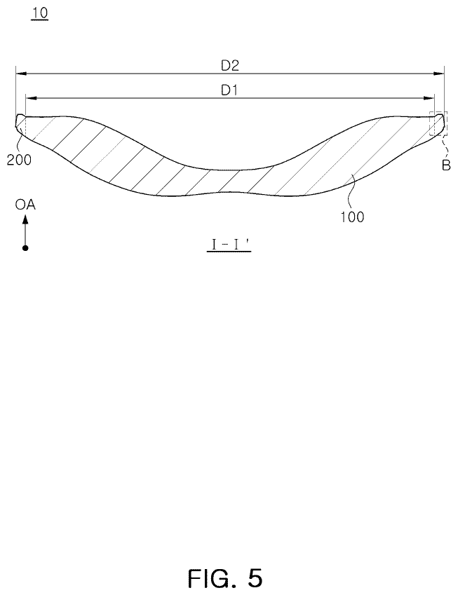

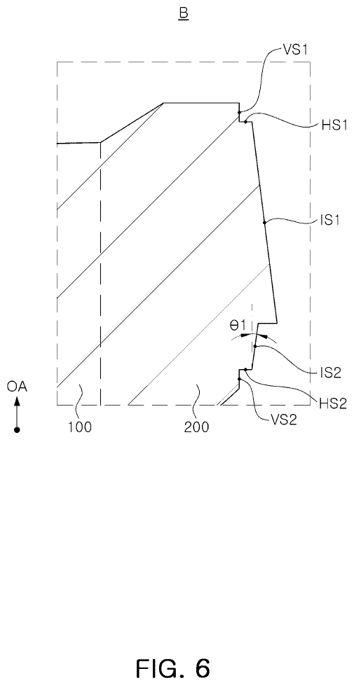

Referring to FIGS. 3 and 4, the lens 10 according to an embodiment of the present disclosure may further include the protrusion 200 extending from the arc portion 120 and spaced apart from the straight portion 110. The protrusion 200 is a portion for improving injection moldability in consideration of a mold structure for injection molding of the lens 10. A description related to the improvement of injection moldability by the protrusion 200 will be described below with reference to FIGS. 5 and 6.

The protrusion 200 may be formed in a portion of the perimeter of the optical portion 100, and the lens 10 of the present embodiment may have the protrusion 200 formed only in the region of the arc portion 120. That is, the lens 10 of the present embodiment may include the straight portion 110 and the arc portion 120 constituting the perimeter of the optical portion 100, the flange portion 300 extending outwardly from the straight portion 110, and the protrusion 200 extending outwardly from the arc portion 120. Meanwhile, unlike the flange portion 300, the protrusion 200 of the present embodiment may correspond to a region unrelated to the assembly structure of the lens and may be disposed so as not to be in contact with an adjacent lens or spacer within the lens barrel.

Referring to FIGS. 3 and 4, the lens 10 of the present embodiment may be formed such that a distance W2 between the outermost surfaces of the flange portions 300 extending from each of the pair of straight portions 110 is less than the maximum diameter D2 of the entire lens 10, including the protrusion 200.

In addition, the ratio (W1/W2) of the distance W1 between the pair of straight portions to the distance W2 between the outermost surfaces of the flange portion 300 extending from each of the straight portions 110 may be greater than 0.80 and less than 0.98.

The distance W2 between the outermost surfaces of the flange portion 300 extending from each of the straight portions 110 is ultimately equal to the short-axis diameter of the entire lens 10, including the flange portions 300. Therefore, if the ratio (W1/W2) is 0.80 or less, the width of the flange portion 300 may become larger than desired, and thus, the size reduction effect may be reduced. In addition, if the ratio (W1/W2) is 0.98 or more, it may be difficult to support and fix the lens 10 within the lens barrel.

Meanwhile, referring to FIG. 4, the ratio (D1/D2) of the maximum diameter D1 of the optical portion 100 to the maximum diameter D2 of the entire lens 10, including the protrusion 200, may be greater than 0.85 and less than 0.98.

The protrusion 200 of the present embodiment may correspond to a region extending to the outside of the arc portion 120 as a configuration for maintaining moldability when the lens 10 is separated from the mold during injection molding. Therefore, the maximum diameter D2 of the entire lens 10, including the protrusion 200, may refer to the diameter passing through the center of the optical axis OA and the outermost boundary line of the protrusion 200. In addition, the maximum diameter D1 of the optical portion 100 may refer to the effective diameter of the lens 10 in the long-axis direction.

If the ratio (D1/D2) of the maximum diameter D1 of the optical portion 100 to the maximum diameter D2 of the entire lens 10 including the protrusion 200 is 0.85 or less, the width of the protrusion 200 may become unnecessarily large, and thus, the size reduction effect may be reduced. In addition, if the ratio (D1/D2) is 0.98 or more, the lens 10 may be deformed due to the opening and closing of the mold during injection molding of the lens.

FIG. 5 is a cross-sectional view taken along line I-I′ of FIG. 1. FIG. 6 is an enlarged view of region B of FIG. 5.

Referring to FIGS. 5 and 6, the protrusion 200 of the present embodiment may have such a cross-section as shown in FIG. 6 in order to secure injection moldability, considering the mold structure for injection molding of the lens 10. The protrusion 200 of the present embodiment is not physically separate from the optical portion 100 and corresponds to a component formed integrally with the optical portion 100, but the region is divided and set with the dotted line for convenience of description.

The protrusion 200 of the present embodiment may include a side connecting an object-side surface and an image sensor-side surface. In the cross-section including the optical axis OA for the lens 10 of the present embodiment, a side surface of the protrusion 200 may include a vertical surface VS parallel to the optical axis OA, a horizontal surface HS perpendicular to the optical axis OA, and an inclined surface IS.

Specifically, the side surface of the protrusion 200 of the present embodiment may include a first vertical surface VS1 and a second vertical surface VS2, parallel to the optical axis OA, a first horizontal surface HS1 and a second horizontal surface HS2, perpendicular to the optical axis OA, and a first inclined surface IS1 and a second inclined surface IS2 inclined in opposite directions.

The side surface of the protrusion 200 of the present embodiment may include a first vertical surface VS1 and a first horizontal surface HS1 connected to the first vertical surface VS1 at an upper end portion based on the direction of FIG. 6 and a second vertical surface VS2 and a second horizontal surface HS2 connected to the second vertical surface VS2 at a lower end portion. In addition, the side surface of the protrusion 200 of the present embodiment may include a first inclined surface IS1 connected to the first horizontal surface HS1 and a second inclined surface IS2 connected to the second horizontal surface HS2.

The first inclined surface IS1 and the second inclined surface IS2 may have inclinations in opposite directions. In addition, the side surface of the protrusion 200 may protrude most in the region between the first inclined surface IS1 and the second inclined surface IS2.

Referring to FIG. 6, an angle θ1 formed by the second inclined surface IS2 and the optical axis OA of the present embodiment may be greater than 3 degrees and less than 20 degrees. If the angle θ1 formed by the second inclined surface IS2 and the optical axis OA is equal to or less than 3 degrees, it may be difficult to prevent lens deformation occurring in the boundary region of the mold during injection molding of the lens 10. In addition, if the angle θ1 formed by the second inclined surface IS2 and the optical axis OA is 20 degrees or more, the region in which the protrusion 200 protrudes outwardly from the lens 10 may increase, and thus, the size reduction effect may be reduced.

In the lens 10 of the present embodiment, based on the cross-section, parallel to the optical axis OA and passing through the protrusion 200, the length of each of the first vertical surface VS1 and the second vertical surface VS2 may be greater than 0.01 mm and less than 0.1 mm. If the length of each of the first vertical surface VS1 and the second vertical surface VS2 is 0.01 mm or less, it may be difficult to prevent molding defects of the lens 10 that may occur in the mold boundary region during injection molding. In addition, if the length of each of the first vertical surface VS1 and the second vertical surface VS2 is 0.1 mm or more, the lens moldability may deteriorate.

In addition, in the lens 10 of the present embodiment, the length of each of the first horizontal surface HS1 and the second horizontal surface HS2, parallel to the optical axis OA and passing through the protrusion 200, may be greater than 0.01 mm and less than 0.1 mm. If the length of each of the first horizontal surface HS1 and the second horizontal surface HS2 is equal to or less than 0.01 mm, it may be difficult to prevent molding defects of lens 10 that may occur in the mold boundary region during injection molding. In addition, if the length of each of the first horizontal surface HS1 and the second horizontal surface HS2 is greater than 0.1 mm or more, the region in which the protrusion 200 protrudes outwardly from the lens 10 may increase, and thus, the size reduction effect may be reduced.

If the side surface of the lens is simply a vertical surface, parallel to the optical axis OA, lens deformation may occur due to the opening and closing of upper and lower molds during the injection molding process. Meanwhile, since the lens 10 of the present embodiment includes the protrusion 200 extending from the arc portion 120 and having the shape described above, the size may be reduced, while the molding defect of the lens is reduced.

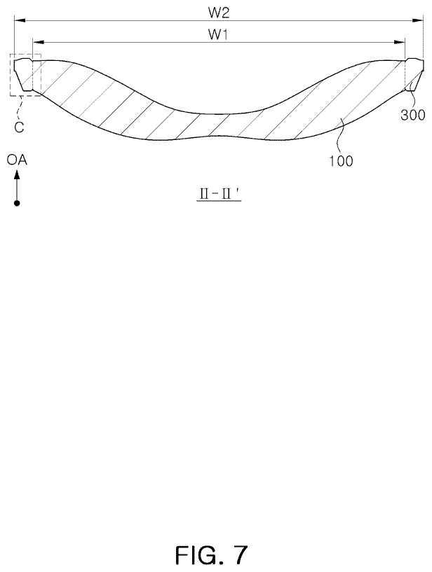

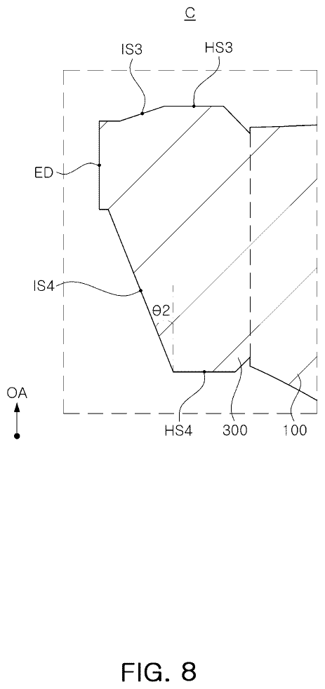

FIG. 7 is a cross-sectional view taken along the line II-II′ of FIG. 1. FIG. 8 is an enlarged view of region C of FIG. 7.

Referring to FIGS. 7 and 8, the flange portion 300 of the present embodiment may have such a cross-section as shown in FIG. 8 in order to improve the moldability of the lens 10 and prevent a flare phenomenon. Here, the flare phenomenon refers to a phenomenon in which light is reflected or scattered inside the lens, thereby lowering image quality.

The flange portion 300 of the present embodiment may include a side surface connecting the object-side surface and the image sensor-side surface. In the cross-section including the optical axis OA of the lens 10 of the present embodiment, the side surface of the flange portion 300 may include the horizontal surface HS, perpendicular to the optical axis OA, the inclined surface IS, and an outer diameter portion ED, parallel to the optical axis OA and forming the outermost boundary. The horizontal surface HS may be a region contacting a spacer SP or an adjacent lens in the direction of the optical axis OA, which will be described below. In addition, the outer diameter portion ED may be a region contacting the lens barrel, which will be described below. However, without being limited thereto, when the lens, including the outer diameter portion ED, is supported and fixed in contact with an adjacent lens or a spacer, the outer diameter portion ED may be spaced apart from the lens barrel.

More specifically, the side surface of the flange portion 300 of the present embodiment may include the outer diameter portion ED disposed to be parallel to the optical axis OA and disposed at the outermost side of a third horizontal surface HS3 and a fourth horizontal surface HS4 perpendicular to the optical axis OA, and a third inclined surface IS3 and a fourth inclined surface IS4 inclined in opposite directions.

The side surface of the flange portion 300 of the present embodiment may include the third horizontal surface HS3 and the third inclined surface IS3 connected to the third horizontal surface HS3 at the upper end portion and a fourth horizontal surface HS4 and a fourth inclined surface IS4 connected to the fourth horizontal surface HS4 at the lower end portion, based on the direction of FIG. 8. In addition, the side surface of the flange portion 300 of the present embodiment may include the outer diameter portion ED disposed to be parallel to the optical axis OA and connecting the third inclined surface IS3 to the fourth inclined surface IS4.

The first inclined surface IS1 and the second inclined surface IS2 may have inclinations in opposite directions. In addition, the side surface of the protrusion 200 may protrude most from the outer diameter ED.

Referring to FIG. 8, an angle θ2 formed by the fourth inclined surface IS4 and the optical axis OA of the present embodiment may be greater than 10 degrees and less than 70 degrees. If the angle θ2 formed by the fourth inclined surface IS4 and the optical axis OA is equal to or less than 10 degrees, the flare phenomenon prevention effect according to the inclined surface of the flange portion 300 may be reduced. In addition, if the angle θ2 formed by the fourth inclined surface IS4 and the optical axis OA is 70 degrees or more, the region in which the flange portion 300 extends to the outside of the straight portion 110 may increase, and thus, the size reduction effect may be reduced.

FIG. 9 is a cross-sectional view of the lens assembly 1000 according to an embodiment of the present disclosure.

Referring to FIG. 9, the lens assembly 1000 according to the present embodiment may include a lens barrel 20, a plurality of lenses L1-L6 accommodated in the lens barrel 20, and a spacer SP disposed between two adjacent lenses. The lens 10 described above with reference to FIGS. 1 to 8 may correspond to at least one of the plurality of lenses L1-L6. The region in which the spacer SP and any one of the lenses L1-L6 are in contact with each other, or the region in which adjacent lenses are in contact with each other, may correspond to the flange portion 300 described above.

The plurality of lenses L1-L6 may be arranged to be spaced apart from each other by a preset distance along the optical axis OA.

In the present embodiment, the plurality of lenses L1-L6 may include a first lens L1, a second lens L2, a third lens L3, a fourth lens L4, a fifth lens L5, and a sixth lens L6 arranged along the optical axis OA from the object side toward the image sensor side.

The first lens L1 may refer to a lens closest to an object (or subject), and the sixth lens L6 may refer to a lens closest to the image sensor.

However, without being limited thereto, the plurality of lenses may include seven or more lenses or may include five or fewer lenses.

The lens assembly 1000 may include a self-aligning structure. That is, the lens assembly 1000 may include a structure in which the optical axes are aligned as at least some of the plurality of lenses are coupled to each other.

Here, the first lens L1 disposed to be closest to the object side is in contact with the lens barrel 20 so that the optical axes are aligned, and the second lens L2 and the third lens L3 may be coupled to another lens (for example, the first lens L1 or the second lens L2) adjacent to the object side so that the optical axes are aligned. For example, the first lens L1 and the second lens L2 may be mutually coupled, and the second lens L2 and the third lens L3 may be mutually coupled so that the optical axes are aligned.

That is, the flange portions of the first lens L1 to the third lens L3 may be coupled to each other so that the optical axes OA of the respective lenses are aligned. An uneven structure may be formed in the flange portion of each lens, and the uneven structures of adjacent lenses may be coupled to each other so that the optical axes OA are aligned.

Meanwhile, unlike the embodiment of FIG. 9, it is also possible for all the lenses of the lens assembly 1000 to be in contact with the lens barrel 20 so that the optical axes OA are aligned.

The spacer SP may be disposed between adjacent lenses L. At least a portion of the flange portion of each lens may be in contact with the spacer SP. The spacer SP may maintain a gap between the lenses L and block unnecessary light.

The spacer SP may include a first spacer SP1, a second spacer SP2, a third spacer SP3, a fourth spacer SP4, a fifth spacer SP5, and a sixth spacer SP6 arranged from the object side toward the image sensor.

The first spacer SP1 may be disposed between the first lens L1 and the second lens L2, the second spacer SP2 may be disposed between the second lens L2 and the third lens L3, the third spacer SP3 may be disposed between the third lens L3 and the fourth lens L4, the fourth spacer SP4 may be disposed between the fourth lens L4 and the fifth lens L5, and the fifth spacer SP5 may be disposed between the fifth lens L5 and the sixth lens L6. In addition, the sixth spacer SP6 may also be disposed between the fifth lens L5 and the sixth lens L6. That is, the fifth spacer SP5 and the sixth spacer SP6 may be sequentially arranged between the fifth lens L5 and the sixth lens L6.

The fifth spacer SP5 may be formed to be the thickest among the plurality of spacers. For example, the thickness of the fifth spacer SP5 in the direction of the optical axis OA may be formed to be greater than the thickness of the other spacers in the direction of the optical axis OA.

Among the plurality of lenses included in the lens assembly 1000, the lens that is in contact with the lens barrel 20 where the optical axis OA is aligned may be the lens 10 described above with reference to FIGS. 1 to 8.

For example, referring to FIG. 9, in the case of the lens assembly 1000 having a self-aligning structure, each of the first lens L1, the fourth lens L4, the fifth lens L5, and the sixth lens L6 in contact with the lens barrel 20 may include the protrusion 200 and the flange portion 300 of the lens 10 described above with reference to FIGS. 1 to 8.

Meanwhile, when all of the plurality of lenses included in the lens assembly 1000 are in contact with the lens barrel 20 and the optical axis OA is aligned, all of the lenses may include the protrusion 200 and the flange portion 300 of the lens 10 described above with reference to FIGS. 1 to 8.

In the case of the lens assembly 1000 according to the present embodiment, a D-cut portion may be formed in the region of the lens barrel 20 in which the lens 10 described above with reference to FIGS. 1 to 8 is coupled. An inner surface and an outer surface of the lens barrel 20 in the portion in which the D-cut portion is formed may be flat.

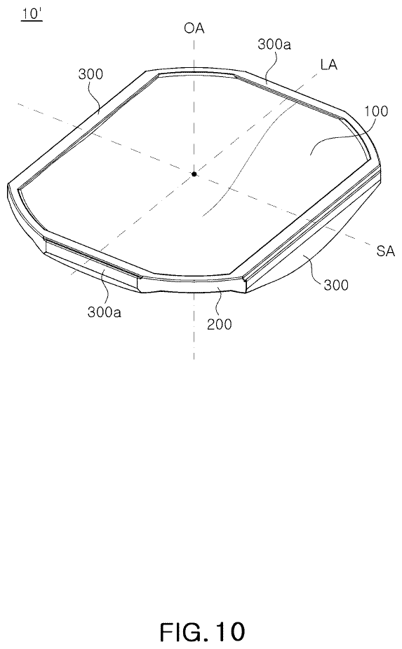

FIG. 10 is a perspective view of a lens 10′ according to another embodiment of the present disclosure.

Comparing FIG. 10 with FIG. 1, the lens 10′ according to the present embodiment is different from the lens 10 according to the embodiment in that the lens 10′ further includes another pair of straight portions facing each other in the long-axis (LA) direction in addition to a pair of straight portions facing each other in the short-axis (SA) direction. Accordingly, the lens 10′ of the present embodiment may also include two pairs of flange portions 300 extending from the straight portion.

Therefore, in describing the present embodiment, only the shape of the lens 10′, different from that of the lens 10 according to an embodiment, and a flange portions 300a additionally arranged to face each other in the long axis (LA) direction will be described, and the description of the lens 10 of the present embodiment may be applied as is to the remaining components.

Referring to FIG. 10, the lens 10′ of the present embodiment may include two pairs of straight portions, one pair in the short axis (SA) direction and one pair in the long axis (LA) direction. Accordingly, arc portions connecting the straight portions may also be configured in two pairs.

In the lens 10′ of the present embodiment, the flange portion 300 extending outwardly from the straight portion may further include the flange portions 300a facing each other in the long axis (LA) direction, in addition to the flange portion 300 facing each other in the short axis (SA) direction. In addition, the lens 10′ of the present embodiment may also include the protrusion portion 200 protruding from the arc portion in four separate regions.

Since the lens 10′ of the present embodiment includes two pairs of straight portions, the lens 10′ has a lens shape close to the image sensor shape, so unnecessary portions in terms of optical function may be further removed, which may be advantageous for miniaturization. In addition, by forming the flange portions 300 and 300a for contact with an assembly configuration, such as a spacer, only in partial regions, the maximum diameter, i.e., the effective diameter, of the arc portion may be maximized in the remaining regions.

Meanwhile, for the convenience of description, the short axis SA and the long axis LA are distinguished from each other, but the diameter relationship in the two axial directions is not limited thereto. That is, the diameter in the short axis (SA) direction and the diameter in the long axis (LA) direction may be the same. In this specification, the short axis SA may correspond to a first axis, the long axis LA may correspond to a second axis, and the second axis may refer to an axis, perpendicular to each of the optical axis OA and the first axis.

Referring to the embodiments, the lenses 10 and 10′ according to the embodiments of the present disclosure and the lens assembly 1000 including the same may reduce the size, while securing optical performance.

The lens and the lens assembly according to one or more embodiments of the present disclosure may be miniaturized by forming the assembly structure only in a portion of the perimeter of the lens, such as by disposing the flange portion in a region in which both sides of a circular lens are partially removed.

The lens, according to one or more embodiments of the present disclosure, may realize the maximum effective diameter within a limited size.

An aspect of the present disclosure is to miniaturize a lens assembly by forming an assembly structure only in a portion of the perimeter of a lens, such as disposing a flange portion in a region in which both sides of a circular lens are partially removed.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens comprising:
an optical portion comprising a pair of straight portions facing each other in a direction perpendicular to an optical axis, and an arc portion connecting the pair of straight portions; and
a flange portion extending along a portion of a perimeter of the optical portion,
wherein the flange portion extends from a straight portion of the straight portions and is spaced apart from the arc portion, and the optical portion refracts light.

2. The lens of claim 1, wherein a distance W1 between the pair of straight portions is less than a maximum diameter D1 of the optical portion.

3. The lens of claim 2, wherein a ratio (W1/D1) of the distance W1 between the pair of straight portions to the maximum diameter D1 of the optical portion is greater than 0.5 and less than 0.9.

4. The lens of claim 1, further comprising:
a protrusion extending from the arc portion and spaced apart from the straight portion of the straight portions,
wherein a distance W2 between outermost surfaces of the flange portion extending from one of the straight portions and another flange portion extending from the other of the straight portions is less than a maximum diameter D2 of the lens including the protrusion.

5. The lens of claim 4, wherein a ratio (W1/W2) of a distance W1 between the pair of straight portions to the distance W2 between the outermost surfaces of the flange portion and the other flange portion respectively extending from the straight portions is greater than 0.80 and less than 0.98.

6. The lens of claim 4, wherein a ratio (D1/D2) of a maximum diameter D1 of the optical portion to the maximum diameter D2 of the lens including the protrusion is greater than 0.85 and less than 0.98.

7. The lens of claim 4, wherein a side surface of the protrusion comprises first and second vertical surfaces, parallel to the optical axis, first and second horizontal surfaces, perpendicular to the optical axis, and first and second inclined surfaces inclined in opposite directions.

8. The lens of claim 7, wherein, based on a cross-section parallel to the optical axis and passing through the protrusion, a length of each of the first and second vertical surfaces is greater than 0.01 mm and less than 0.1 mm.

9. The lens of claim 7, wherein, based on a cross-section parallel to the optical axis and passing through the protrusion, a length of each of the first and second horizontal surfaces is greater than 0.01 mm and less than 0.1 mm.

10. The lens of claim 7, wherein an angle between the second inclined surface and the optical axis is greater than 3 degrees and less than 20 degrees.

11. The lens of claim 1, wherein a side surface of the flange portion comprises an outer diameter portion disposed at an outermost side parallel to the optical axis, third and fourth horizontal surfaces perpendicular to the optical axis, and third and fourth inclined surfaces inclined in opposite directions.

12. The lens of claim 11, wherein an angle between the fourth inclined surface and the optical axis is greater than 10 degrees and less than 70 degrees.

13. The lens of claim 1, wherein
the pair of straight portions face each other in a first axis direction, and
the optical portion further comprises another pair of straight portions facing each other in a second axis direction perpendicular to the optical axis and the first axis, and further comprises flange portions respectively extending from the other pair of straight portions.

14. A lens assembly comprising:
a lens barrel;
a plurality of lenses stacked in a direction of an optical axis within the lens barrel, each lens in the plurality of lenses comprising an optical portion refracting light and a flange portion extending along a perimeter of the optical portion; and
a spacer disposed between two adjacent lenses among the plurality of lenses,
wherein the optical portion comprises a pair of straight portions facing each other in a direction perpendicular to the optical axis, and an arc portion connecting the pair of straight portions, the flange portion extends from the straight portion and is spaced apart from the arc portion, and the spacer is in contact with the flange portion.

15. The lens assembly of claim 14, wherein a curvature of the straight portion is less than a curvature of the arc portion.

16. The lens assembly of claim 14, wherein a side surface of the flange portion comprises a horizontal surface perpendicular to the optical axis, and an outer diameter portion disposed at an outermost side parallel to the optical axis, the horizontal surface is in contact with the spacer, and the outer diameter portion is in contact with the lens barrel.
